(19) United States
(12) Patent Application Publication
(10) Pub. No.: US 2017/0153699 A1
(43) Pub. Date: Jun. 1, 2017

(54) SIGHT LINE INPUT PARAMETER CORRECTION APPARATUS, AND SIGHT LINE INPUT APPARATUS

(71) Applicant: DENSO CORPORATION, Kariya-city, Aichi-pref. (JP)

(72) Inventor: Yoshiyuki TSUDA, Kariya-city (JP)

(21) Appl. No.: 15/322,192

(22) PCT Filed: Jun. 18, 2015
(86) PCT No.: PCT/JP2015/003061

§ 371 Date: Dec. 27, 2016

(30) Foreign Application Priority Data
Jul. 8, 2014 (JP) 2014-140628

(51) Int. Cl. G06F 3/01; G06F 3/03

(52) U.S. Cl. CPC G06F 3/013; G06F 3/0304; G06F 3/0482

(57) ABSTRACT

A sight line input parameter correction apparatus includes: an image acquisition portion that acquires a face image of a user; a sight line detection portion that detects a line of sight position of the user; a gaze point map generation portion that specifies areas where a line of sight remains on a screen of a display device; a storage device that stores information on an image group displayed on the display device; and a correction portion that compares the areas obtained by the gaze point map generation portion with the information on the image group, estimates correlations between the areas and images of the image group, and corrects a parameter of the sight line detection portion. The correction portion does not correct the parameter when a total number of the areas specified by the gaze point map generation portion is less than a predetermined number.

### CROSS REFERENCE TO RELATED APPLICATION

The present application is based on Japanese Patent Application No. 2014-140628 filed on Jul. 8, 2014, the disclosure of which is incorporated herein by reference.

### TECHNICAL FIELD

The present disclosure relates to a sight line input parameter correction apparatus, and a sight line input apparatus.

### BACKGROUND ART

A method that corrects a line-of-sight input parameter based on a marker position indicated at a start of an event performed by a user, and on a line-of-sight direction detected by a line-of-sight sensor at the start of the event is known as a technology for automatically correcting the line-of-sight input parameter without troubling a user (for example, see Patent Literature 1).

The inventor of the present application has found the following. A parameter correction method described in Patent Literature 1 uses a line-of-sight direction at a start of an event as a line-of-sight direction corresponding to a marker position at the start of the event. According to this method, however, a line-of-sight input parameter may be inaccurately corrected when a user performs the event while intentionally gazing at a position that is not supposed to be viewed by the user for operation of a marker due to considerable deviation of the parameter before correction, for example. In this case, line-of-sight detection accuracy may further deteriorate after the correction.

### PRIOR ART LITERATURES

### Patent Literature

Patent Literature 1: JP 2000-10723 A

### SUMMARY OF INVENTION

It is an object of the preset disclosure to provide a sight line input parameter correction apparatus and a sight line input apparatus, which enable to automatically and accurately correct a line-of-sight input parameter.

According to a first aspect of the present disclosure, a sight line input parameter correction apparatus determines an image viewed by a user from an image group displayed on a display device. The sight line input parameter correction apparatus includes: an image acquisition portion that acquires a face image of the user; a sight line detection portion that detects a line of sight position of the user based on the face image, which is acquired; a gaze point map generation portion that specifies a plurality of areas where a line of sight remains on a screen of the display device based on a detection result of the sight line detection portion; a storage device that stores information on the image group displayed on the display device; and a correction portion that compares the plurality of areas obtained by the gaze point map generation portion with the information on the image group stored in the storage device, the correction portion estimating correlations between the plurality of areas and images of the image group, the correction portion correcting a parameter of the sight line detection portion based on an estimation result.

According to the sight line input parameter correction apparatus, the parameter is corrected with correlations between the multiple areas where the line of sight remains on the screen of the display device and the images of the image group on the display screen. Accordingly, it is possible to accurately correct the line-of-sight input parameter in comparison with a method that corrects the parameter based on the line of sight of the user at a start of an event.

According to a second aspect of the present disclosure, a sight line input apparatus causes a display device to display an image group and determines an image to be selected by a user from the image group by determining an image viewed by the user. The sight line input apparatus includes: an image acquisition portion that acquires a face image of the user; a sight line detection portion that detects a line of sight position of the user based on the face image, which is acquired; a display controller that causes the display device to display the image group; a gaze point map generation portion that specifies a plurality of areas where a line of sight remains on a screen of the display device based on a detection result obtained by the sight line detection portion; a storage device that stores information on the image group displayed on the display device; a correction portion that compares the plurality of areas obtained by the gaze point map generation portion with positions of images of the image group stored in the storage device, the correction portion estimating correlations between the plurality of areas and the images of the image group, the correction portion correcting a parameter of the sight line detection portion based on an estimation result; and a determination portion that determines an image currently viewed by the user from the image group displayed on the display device based on the parameter corrected by the correction portion, The display controller replaces the image group with a new image group when a decision operation is input for the image viewed by the user after determination by the determination portion that the image is viewed by the user.

According to the sight line input apparatus, the parameter is corrected based on correlations between the multiple areas where the line of sight remains on the screen of the display device and the images of the image group on the display screen similarly to the sight line input parameter correction apparatus. Accordingly, it is possible to accurately correct the line-of-sight input parameter in comparison with a method that corrects the parameter based on the line of sight of the user at a start of an event.

According to the sight line input parameter correction apparatus and the sight line input apparatus, it is possible to automatically and accurately correct a line-of-sight input parameter.

### BRIEF DESCRIPTION OF DRAWINGS

The above and other aspects, features and advantages of the present disclosure will become more apparent from the following detailed description made with reference to the accompanying drawings. In the drawings:

FIG. 1 is a block diagram illustrating a configuration of a sight line input apparatus and a sight line input parameter correction apparatus according to an embodiment;

FIG. 2 is a view visually illustrating a specific example of correction performed by a correction portion;

FIG. 3 is a flowchart showing a method for correcting a line-of-sight input parameter;

FIG. 4 is a view illustrating an example of display of an image group, which is displayed, replaced with a new image group based on a decision input from a user; and

FIG. 5 is a view illustrating an example of correction using an image group containing images arranged in a V shape or a fan shape.

### DESCRIPTION OF EMBODIMENTS

An embodiment is hereinafter described with reference to the drawings. Similar configuration elements included in the embodiment are given identical reference numbers. The same explanation for these elements may be omitted where appropriate.

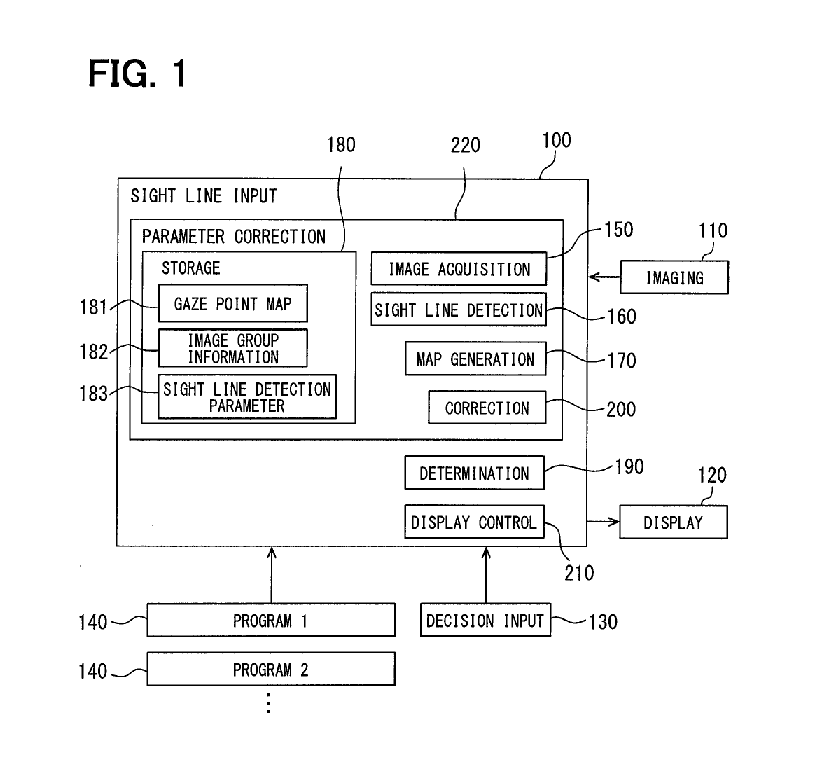

FIG. 1 is a block diagram illustrating a configuration of a sight line input apparatus 100 and a sight line input parameter correction apparatus 220 according to this embodiment. The sight line input parameter correction apparatus 220 is also referred to as a sight line input parameter correction apparatus or a correction apparatus of a line-of-sight input parameter. The sight line input apparatus 100 according to this embodiment is carried on a vehicle (not shown). The sight line input apparatus 100 determines, based on images captured by an imaging device 110 provided on a dashboard or a steering column, an image viewed by a passenger of the vehicle (user of the sight line input apparatus 100) from an image group displayed on a vehicle onboard display device 120 such as a center meter and a head-up display. When decision is input through a decision input portion 130 such as a steering switch, the sight line input apparatus 100 executes an application program 140 corresponding to the image viewed by the user.

Constituent elements of the sight line input apparatus 100 are hereinafter described. The sight line input apparatus 100 according to this embodiment includes an image acquisition portion (a face image acquisition portion) 150 that acquires an image of the face of a user from the imaging device 110, a sight line detection portion 160 that repeatedly detects a line-of-sight position of the user based on the face image, a gaze point map generation portion 170 that specifies multiple areas where a line of sight remains on a screen of the display device 120 for a specific period (such as 2 to 3 seconds) based on a detection result obtained by the sight line detection portion 160, a storage device 180 that stores information on an image group displayed on the display device 120 for the specific period, a determination portion 190 that determines an image currently viewed by the user from the image group displayed on the display device 120 based on the line-of-sight position detected by the sight line detection portion 160 and a line-of-sight input parameter stored in the storage device 180, a correction portion 200 that corrects the line-of-sight input parameter based on the information on the image group stored in the storage device and on a gaze point map, and a display controller 210 that changes a display mode of the display device 120 based on the image currently viewed by the user and/or a decision input operation. The sight line may be referred to as a line of sight, and thus the sight line input may be referred to as a line-of-sight input.

The display controller 210 causes the display device 120 to display an image group in accordance with a state of execution of an application program currently executed. When the determination portion 190 determines an image viewed by the user and then performs an input operation to determine the image viewed by the user, the display controller 210 changes the state of the application program currently executed to replace the image group currently displayed to a new image group.

Each of line-of-sight positions repeatedly detected by the sight line detection portion 160 is given (X, Y) coordinates. The gaze point map generation portion 170 specifies multiple areas where the line of sight remains on the screen of the display device 120 by using the (X, Y) coordinates, and causes the storage device to store the specified areas as a gaze point map.

The image acquisition portion 150, the sight line detection portion 160, the gaze point map generation portion 170, the storage device 180, and the correction portion 200 included in the constituent elements of the sight line input apparatus 100 constitute the sight line input parameter correction apparatus 220 according to this embodiment.

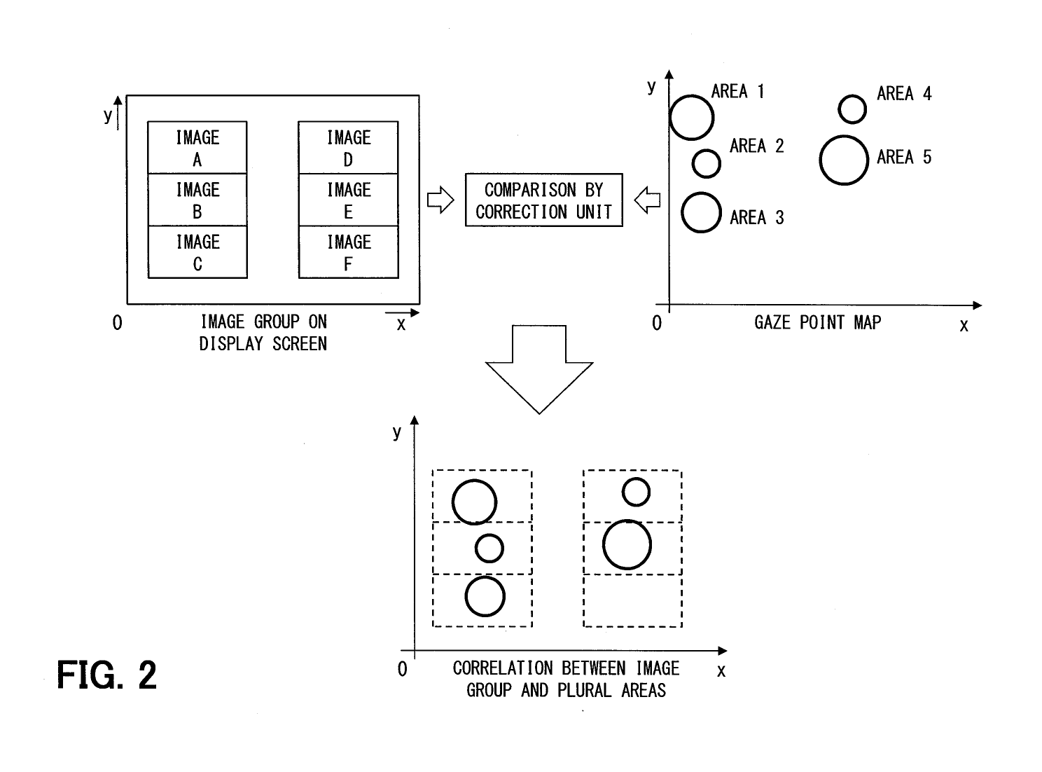

FIG. 2 is a view visually illustrating a specific example of control performed by the correction portion 220. A square frame located in an upper left part in FIG. 2 illustrates an arrangement example of an image group (button screens A to F) displayed on the display device 120 for a specific period for obtaining line-of-sight data corresponding to a source of a gaze point map. A coordinate system located in an upper right in FIG. 2 illustrates an example of a gaze point map generated by the gaze point map generation portion 170 based on the line-of-sight data obtained in the specific period. The correction portion 220 loads these image group arrangement information and the gaze point map from the storage device 180, and compares a positional relationship between the images in the image group with a positional relationship of the areas in the gaze point map to estimate correlations between the multiple areas and the images in the image group. The correction portion corrects the line-of-sight input parameter based on the estimated correlations, and stores the corrected line-of-sight input parameter in the storage device 180.

Accordingly, the gaze point map is updated through an overview by the user for multiple image groups displayed on the display screen. The line-of-sight input parameter is therefore corrected and updated to a new parameter based on the updated gaze point map and the arrangement information on the image groups actually displayed. Accordingly, it is possible to perform accurate correction of the line-of-sight input parameter without troubling the user.

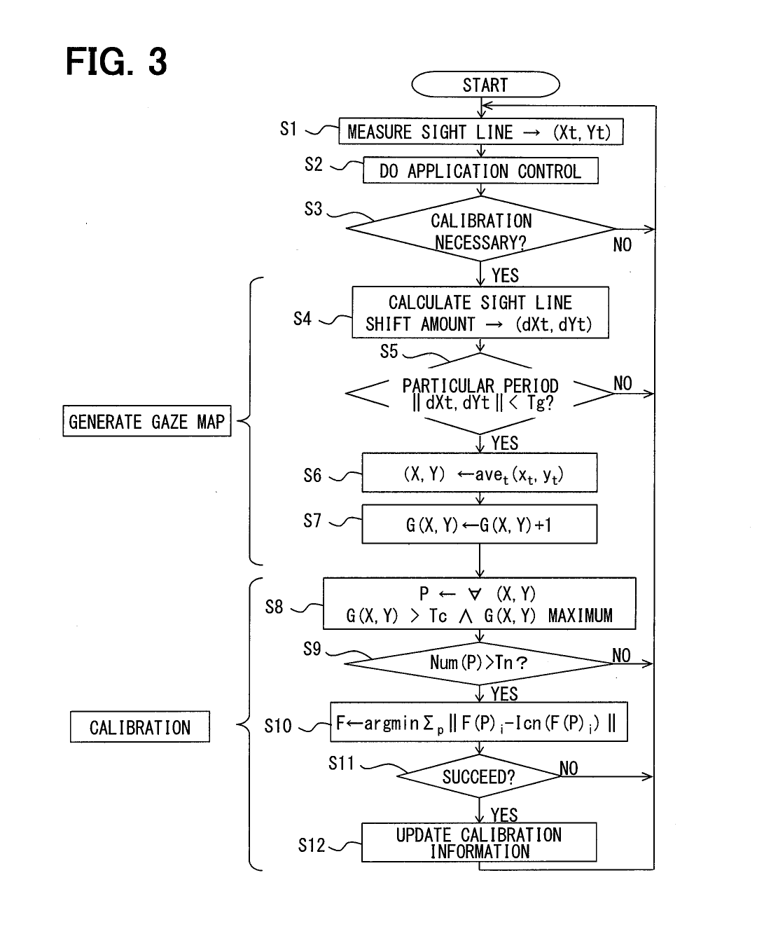

FIG. 3 is a flowchart specifically showing a method for correcting a line-of-sight input parameter described in FIG. 2.

In S1, a line-of-sight position is initially measured by the sight line detection portion 160 based on an image acquired from the imaging device 110 by using the image acquisition portion 150. Subsequently, (X, Y) coordinates are given to the measured line-of-sight position.

In S2, the (X, Y) coordinates at the line-of-sight position measured in S1, and an image group displayed on the display device 120 under an application program currently executed by the display controller 210 as an image group used for correction of the line-of-sight input parameter, are both stored in the storage device 180 along with time data.

In S3, it is determined whether immediate correction of the line-of-sight input parameter (calibration) is necessary. When it is determined that immediate correction is not necessary, the process returns to S1. The necessity of correction of the line-of-sight input parameter may be determined by using various methods. It is preferable, for example, to determine the necessity of correction based on determination of whether or not the line-of-sight position lies within a predetermined range (such as 1.5 times larger than display screen area) for a specific period (such as 2 to 3 seconds).

When it is determined that immediate correction of the line-of-sight input parameter is necessary in S3, a shift speed of the line of sight at each time t (instantaneous shift amount: dxt, dyt) is calculated based on the (X, Y) coordinates of the line-of-sight position at each time t accumulated in the storage device 180 in a previous specific period (such as 2 to 3 seconds) in S4. Thereafter, the process proceeds to S5.

In S5, it is determined whether the shift speed of the line of sight at each time t during the specific period calculated in S4 becomes lower than a predetermined threshold speed (Tg: 100 deg/sec, for example) for a particular period. When it is determined that the shift speed does not become lower than the predetermined threshold speed (Tg) for a predetermined period (such as 0.2 to 0.3 seconds) at any time, i.e., when “NO” is determined in S5, the process returns to S1. When the shift speed becomes higher than the predetermined threshold speed (Tg) for the predetermined period at least at any time, i.e., when “YES” is determined in S5, the process proceeds to S6. This step removes an area corresponding to an extremely short line-of-sight remaining period as noise from areas of targets corresponding to certain line-of-sight remaining periods. Accordingly, it is possible to perform highly accurate parameter correction utilizing noise-free data.

In S6, a position at which the line of sight remains on the screen of the display device 120 is determined by using a set of line-of-sight position data obtained at each time corresponding to a lower shift speed of the line of sight than the predetermined speed for a particular period. More specifically, average position coordinates (avet (xt, yt)) are calculated from line-of-sight position data obtained at each time corresponding to a lower speed than the predetermined speed for the particular period.

In S7, the average position coordinates (avet (xt, yt)) calculated in S6 are added to the gaze point map (G (X, Y)) provided within the storage device 180 as a new gaze point (X, Y), and then the process proceeds to S8. For example, a state that the line of sight remains for a particular period is determined as gaze, and added to the gaze point map.

In S8, multiple gaze point groups (G (X, Y) maximum: hereinafter referred to as clusters) containing a predetermined number or more of gaze points are extracted from multiple gaze points (X, Y) accumulated in the gaze point map (G (X, Y)), and then the process proceeds to S9. The multiple clusters selected in S8 correspond to areas 1 to 5 shown in the gaze point map illustrated in FIG. 2, respectively. The detected line-of-sight positions are divided into appropriate groups (clusters), and specified as multiple areas in this manner so as to allow matching between the respective areas and the images contained in the image group displayed on the display device. For example, points gazed more frequently in the gaze point map and corresponding to local maximum values (maximums) are extracted as clusters.

In S9, it is determined whether or not the number of clusters (Nm(P)) extracted in S8 exceeds a predetermined number (Tn). When it is determined that the extracted number of clusters (Nm(P)) is the predetermined number (Tn) or less, this determination is regarded as a state that a sufficient number of data for correction of the line-of-sight input parameter is not yet obtained. In this case, the process returns to S1. Accordingly, correction for a small number of areas inappropriate for parameter correction is not performed. When it is determined that the extracted number of clusters (Nm(P)) exceeds the predetermined number (Tn), the process proceeds to S10. The predetermined number (Tn) is dependent on the number and arrangement of the images of the displayed image group. The minimum number of the predetermined number (Tn) is determined beforehand.

In S10, the position coordinates of the extracted clusters are matched with the position coordinates of the images of the image group displayed on the display device 120 for the specific period under the application program currently executed by the display controller 210. Thereafter, a correction value candidate (F) of the line-of-sight input parameter is calculated based on a predetermined algorithm.

Hereinafter described is an example that adopts a linear function F(X, Y) representing a line-of-sight input parameter by using line-of-sight position coordinates as an argument. Assumed herein are Xbef, Ybef as line-of-sight position coordinates calculated at the original by the sight line detection portion 160, Xaft, Yaft as line-of-sight position coordinates reflecting the line-of-sight input parameter, and ax, ay, bx, and by as constants corresponding to correction targets. In this case, F(X, Y) is expressed as (Xaft=ax*Xbef+by, Yaft=ay*Xbef+by).

The predetermined algorithm in S10 may be an algorithm that calculates a distance between each cluster i and an image closest to the coordinates of the corresponding cluster i, and calculates the variables ax, ay, bx, and by producing the minimum sum of the calculated distances, while varying the variables ax, ay, bx, and by of the linear function F(X, Y), for example. An error is assumed herein as a difference between each point F(P) of the varied linear function F(X, Y) and icon coordinates Icn closest to coordinates of the corresponding point F(P). The linear function F(X, Y) may be determined as a linear function that minimizes the sum of the errors.

In S11, it is verified whether or not a correction value candidate of the line-of-sight input parameter calculated in S10 is correct. When it is determined that the correction value candidate is correct, the process proceeds to S12. When it is determined that the correction value candidate is not correct, the process returns to S1. Whether or not the correction value candidate of the line input parameter is correct may be verified by using various methods. It is preferable, for example, to verify the correctness based on determination of whether or not the distance between (Xaft, Yaft) and the image, i.e., the sum of residual errors is smaller than a threshold.

In S13, a line-of-sight input parameter (C) included in the storage device 180 is replaced with the correction value candidate (F) of the line-of-sight input parameter calculated in S10 as correction performed by the correction portion 200.

According to the embodiment described above, a parameter is corrected based on correlations between the multiple areas where the line of sight remains on the screen of the display device 120, and the images of the image group on the display screen. Accordingly, it is possible to accurately perform correction of the line-of-sight input parameter in comparison with a method that corrects a parameter based on the line of sight of the user at the time of some decision input.

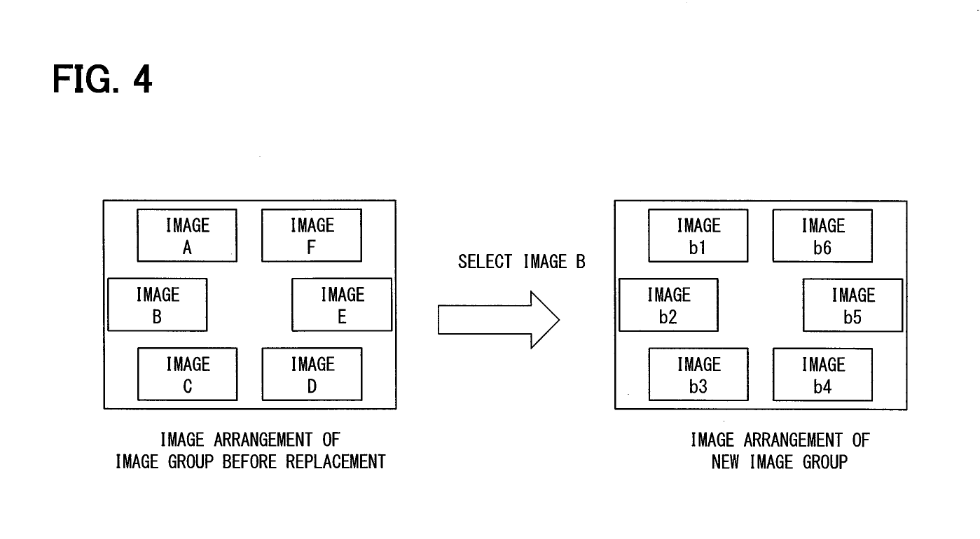

FIG. 4 illustrates an example of a change produced by the display controller 210 in response to input to a decision input portion 130 from the user concerning a state of an application program currently executed so as to replace an image group currently displayed with a new image group. The replacement of the image group illustrated in FIG. 4 is characterized by the use of a new image group containing images disposed in arrangement identical to arrangement of the images of the image group before replacement. According to this structure, the position information on the multiple areas accumulated based on the image group before replacement can be compared with the images of the new image group as well, and therefore it is possible to correct the parameter more accurately.

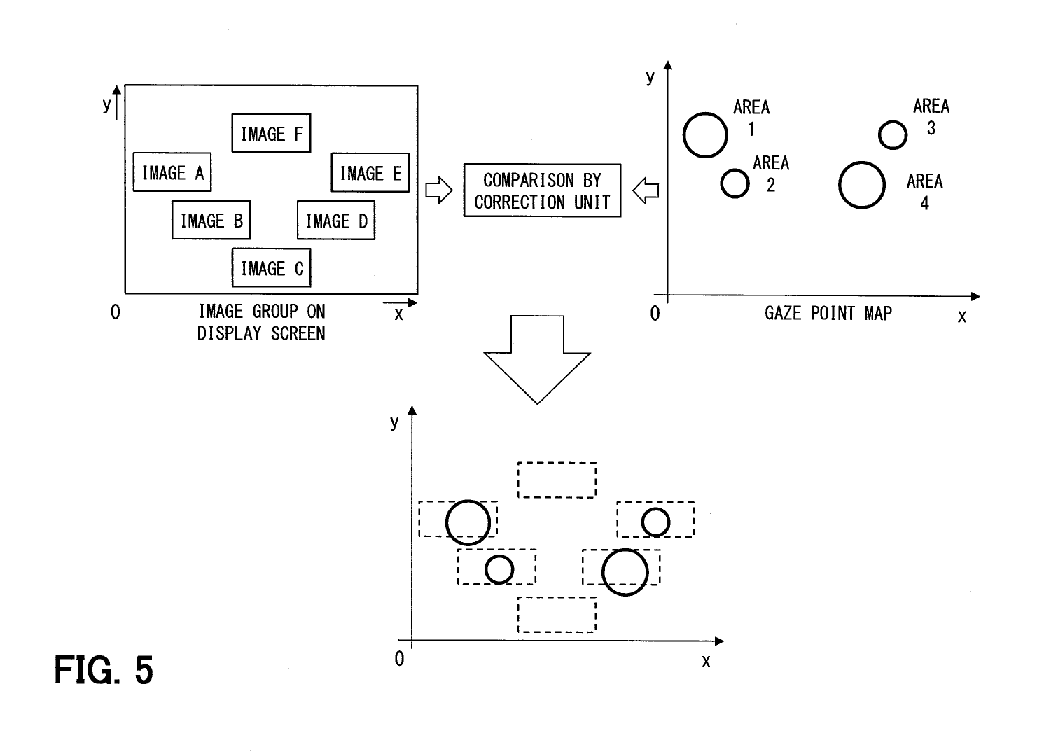

While the images of the image group illustrated in FIG. 4 are arranged in an annular shape, images of an image group illustrated in FIG. 5 are arranged in a V shape or a fan shape. When the images of the image group are arranged in this manner, correlations between the multiple areas and the images of the image group are easily established even for a small number of the multiple areas where the line-of-sight remains on the screen. In other words, the minimum value for the predetermined number (Tn) in this arrangement becomes less than the corresponding minimum value when the images of the image group are evenly vertically and horizontally arranged in matrix.

Summarizing the above, a sight line input parameter correction apparatus determines an image viewed by a user from an image group displayed on a display device. The sight line input parameter correction apparatus includes: an image acquisition portion that acquires a face image of the user; a sight line detection portion that detects a line of sight position of the user based on the acquired face image; a gaze point map generation portion that specifies multiple areas where a line of sight remains on a screen of the display device based on a detection result obtained by the sight line detection portion; a storage device that stores information on the image group displayed on the display device; and a correction portion that compares the multiple areas obtained by the gaze point map generation portion with the information on the image group stored in the storage device, estimates correlations between the multiple areas and images of the image group, and corrects a parameter of the sight line detection portion based on an estimation result obtained by the estimation.

According to the sight line input parameter correction apparatus, the parameter is corrected based on correlations between the multiple areas where the line of sight remains on the screen of the display device and the images of the image group on the display screen. Accordingly, it is possible to perform a line-of-sight input parameter correction in comparison with a method that corrects the parameter based on the line of sight of the user at a start of an event.

According to the sight line input parameter correction apparatus, the gaze point map generation portion may remove an area corresponding to a line-of-sight remaining period shorter than a predetermined period as noise from the multiple areas corresponding to targets where the line of sight remains. It is possible to perform more accurate parameter correction by using the multiple noise-free areas.

According to the sight line input parameter correction apparatus, the correction portion may omit correction of the parameter when the number (a total number) of areas specified by the gaze point map generation portion is less than a predetermined number. This structure does not perform correction for a small number of areas inappropriate for parameter correction.

According to the sight line input parameter correction apparatus, the gaze point map generation portion may calculate a shift speed of the line of sight, determine that the line of sight remains when the shift speed is lower than a predetermined speed, store multiple line-of-sight positions determined as points where the line of sight remains, and divide the multiple stored line-of-sight positions into multiple groups to specify the multiple areas. This structure divides the detected line-of-sight positions into appropriate groups, and specifies these positions as multiple areas.

A sight line input apparatus causes a display device to display an image group and determines an image viewed by a user so that an image to be selected by the user is determined from the image group. The sight line input apparatus includes: an image acquisition portion that acquires a face image of the user; a sight line detection portion that detects a line-of-sight position of the user based on the acquired face image; a display controller that causes the display device to display the image group; a gaze point map generation portion that specifies multiple areas where a line of sight remains on a screen of the display device based on a detection result obtained by the sight line detection portion; a storage device that stores information on the image group displayed on the display device; a correction portion that compares the multiple areas obtained by the gaze point map generation portion with positions of images of the image group stored in the storage device, estimates correlations between the multiple areas and the images of the image group, and corrects a parameter of the sight line detection portion based on an estimation result obtained by the estimation; and a determination portion that determines an image currently viewed by the user from the image group displayed on the display device based on the parameter corrected by the correction portion. The display controller replaces the image group with a new image group when a decision operation is input to the image viewed by the user after determination by the determination portion that the image is viewed by the user.

According to the sight line input apparatus, the parameter is corrected based on correlations between the multiple areas where the line of sight remains on the screen of the display device and the images of the image group on the display screen similarly to the sight line input parameter correction apparatus. Accordingly, it is possible to perform the line-of-sight input parameter correction in comparison with a method that corrects the parameter based on the line of sight of the user at a start of an event.

According to the sight line input apparatus, the display controller may display an image group that contains images arranged in an annular shape, a V shape, or a fan shape on the display device. When the images of the image group are arranged in this manner, correlations between the multiple areas and the images of the image group are easily established even for a small number of the multiple areas where the line-of-sight remains on the screen.

According to the sight line input apparatus, the display controller may use the new image group that contains images disposed in arrangement identical to arrangement of the image group before replacement. According to this structure, the position information on the multiple areas accumulated based on the image group before replacement is applicable to the images of the new image group as well, and therefore more accurate parameter correction is achievable.

It is noted that a flowchart or the processing of the flowchart in the present application includes multiple steps (also referred to as sections), each of which is represented, for instance, as S1. Further, each step can be divided into several sub-steps while several steps can be combined into a single step.

While various embodiments, configurations, and aspects of a sight line input parameter correction apparatus and a sight line input apparatus have been exemplified, the embodiments, configurations, and aspects of the present disclosure are not limited to those described above. For example, embodiments, configurations, and aspects obtained from an appropriate combination of technical elements disclosed in different embodiments, configurations, and aspects are also included within the scope of the embodiments, configurations, and aspects according to the sight line input parameter correction apparatus and the sight line input apparatus.

What is claimed is:

1. A sight line input parameter correction apparatus that determines an image viewed by a user from an image group displayed on a display device, the sight line input parameter correction apparatus comprising:
an image acquisition portion that acquires a face image of the user;
a sight line detection portion that detects a line of sight position of the user based on the face image, which is acquired;
a gaze point map generation portion that specifies a plurality of areas where a line of sight remains on a screen of the display device based on a detection result of the sight line detection portion;
a storage device that stores information on the image group displayed on the display device; and
a correction portion that compares the plurality of areas obtained by the gaze point map generation portion with the information on the image group stored in the storage device, the correction portion estimating correlations between the plurality of areas and images of the image group, the correction portion correcting a parameter of the sight line detection portion based on an estimation result,
wherein:
the correction portion does not correct the parameter when a total number of the areas specified by the gaze point map generation portion is less than a predetermined number.

2. The sight line input parameter correction apparatus according to claim 1, wherein:
the gaze point map generation portion removes an area corresponding to a line-of-sight remaining period shorter than a predetermined period as noise from the plurality of areas where the line of sight remains.

3. (canceled)

4. The sight line input parameter correction apparatus according to claim 1, wherein:
the gaze point map generation portion calculates a shift speed of the line of sight;
the gaze point map generation portion determines that the line of sight remains when the shift speed is lower than a predetermined speed;
the gaze point map generation portion stores a plurality of line-of-sight positions determined as points where the line of sight remains; and
the gaze point map generation portion divides the plurality of stored line-of-sight positions into a plurality of groups to specify the plurality of areas.

5. A sight line input apparatus that causes a display device to display an image group and determines an image to be selected by a user from the image group by determining an image viewed by the user, the sight line input apparatus comprising:
an image acquisition portion that acquires a face image of the user;
a sight line detection portion that detects a line of sight position of the user based on the face image, which is acquired;
a display controller that causes the display device to display the image group;
a gaze point map generation portion that specifies a plurality of areas where a line of sight remains on a screen of the display device based on a detection result obtained by the sight line detection portion;
a storage device that stores information on the image group displayed on the display device;
a correction portion that compares the plurality of areas obtained by the gaze point map generation portion with positions of images of the image group stored in the storage device, the correction portion estimating correlations between the plurality of areas and the images of the image group, the correction portion correcting a parameter of the sight line detection portion based on an estimation result; and
a determination portion that determines an image currently viewed by the user from the image group displayed on the display device based on the parameter corrected by the correction portion,
wherein:
the display controller replaces the image group with a new image group when a decision operation is input for the image viewed by the user after determination by the determination portion that the image is viewed by the user; and
the correction portion does not correct the parameter when a total number of the areas specified by the gaze point map generation portion is less than a predetermined number.

6. The sight line input apparatus according to claim 5, wherein:
the display controller causes the display device to display an image group that contains images arranged in an annular shape, a V shape, or a fan shape.

7. The sight line input apparatus according to claim 5, wherein:
the display controller uses the new image group that contains images disposed in arrangement identical to arrangement of the image group before replacement.
